(19) United States
(12) Patent Application Publication
(10) Pub. No.: US 2017/0235171 A1
(43) Pub. Date: Aug. 17, 2017

(54) ARRAY SUBSTRATE AND MANUFACTURE METHOD THEREOF, DISPLAY DEVICE

(71) Applicant: Wuhan China Star Optoelectronics Technology Co., Ltd., Wuhan, Hubei (CN)

(72) Inventor: Yue MA, Shenzhen, Guangdong (CN)

(73) Assignee: Wuhan China Star Optoelectronics Technology Co., Ltd., Wuhan, Hubei (CN)

(21) Appl. No.: 14/907,556

(22) PCT Filed: Dec. 31, 2015
(86) PCT No.: PCT/CN2015/100329

§ 371 Date: Jan. 25, 2016

(30) Foreign Application Priority Data
Sep. 25, 2015 (CN) 201510623616.9

(51) Int. Cl. G02F 1/1368; G02F 1/1362; G02F 1/1333; G02F 1/1335

(52) U.S. Cl. CPC G02F 1/1368; G02F 1/133514; G02F 1/136286; G02F 1/133345; G02F 2201/07; G02F 2202/10; G02F 2201/121; G02F 2201/123

(57) ABSTRACT

The present invention provides an array substrate, and the array substrate includes a substrate, a buffer layer, a semiconductor layer, a gate isolation layer, a gate metal layer, a source drain metal layer, a flat layer, an interlayer insulation layer, a common electrode layer, a passivation layer and a pixel electrode layer, which are sequentially formed on the substrate, wherein the array substrate further comprises a common signal adjustment structure formed at the common electrode layer, and the common signal adjustment structure and the common electrode layer are together employed to be a common electrode for transmitting a common signal to reduce a resistance in a common signal transmission process. The present invention further provides the aforesaid array substrate and a manufacture method thereof, a display device.

### CROSS REFERENCE

This application claims the priority of Chinese Patent Application No. 201510623616.9, entitled “Array substrate and manufacture method thereof, display device”, filed on Sep. 25, 2015, the disclosure of which is incorporated herein by reference in its entirety.

### FIELD OF THE INVENTION

The present invention relates to a display technology field, and more particularly to an array substrate and a manufacture method thereof, a display device.

### BACKGROUND OF THE INVENTION

With the constant development of the TFT (Thin Film Transistor) liquid crystal display technology, the TFT display device based on LTPS (Low Temperature Poly-silicon) skill possessing properties of low power consumption, high resolution, fast response speed and high aperture ratio has already become the mainstream, and widely applied in kinds of electronic apparatuses, like being applied in the digital electronic apparatuses, such as liquid crystal television, smart phone, tablet and digital camera. However, most of the LTPS TFT array substrate according to prior art transmits the common signal only through the common electrode layer. The resistance in the transmission process is larger, and the common signal distribution is uneven.

### SUMMARY OF THE INVENTION

The present invention provides an array substrate and a manufacture method thereof, a display device, which can effectively reduce the resistance of the common signal in the common signal transmission process, and make the common signal distribution even.

On one aspect, the present invention provides an array substrate, and the array substrate comprises a substrate, a buffer layer, a semiconductor layer, a gate isolation layer, a gate metal layer, a source drain metal layer, a flat layer, an interlayer insulation layer, a common electrode layer, a passivation layer and a pixel electrode layer, which are sequentially formed on the substrate, wherein the array substrate further comprises a common signal adjustment structure formed at the common electrode layer, and the common signal adjustment structure and the common electrode layer are together employed to be a common electrode for transmitting a common signal to reduce a resistance in a common signal transmission process.

The common signal adjustment structure comprises a metal layer between the flat layer and the common electrode layer, and the metal layer is formed by other material with a better electrical conductivity, and a resistance thereof is smaller than common electrode layer.

The metal layer is formed by molybdenum or alloy of aluminum, niobium, molybdenum.

The common signal adjustment structure comprises a first through hole formed at the common electrode layer, which penetrates to the gate metal layer to connect the common electrode layer and the gate metal layer.

The common signal adjustment structure comprises a second through hole formed at the common electrode layer, which penetrates to the source drain metal layer to connect the common electrode layer and the source drain metal layer.

The present invention further provides a display device, comprising the aforesaid array substrate, a color film substrate and a liquid crystal layer sandwiched between the array substrate and the color film substrate.

On another aspect, the present invention provides a manufacture method of an array substrate, and the method comprises:

providing a substrate, and sequentially forming a buffer layer, a semiconductor layer, a gate isolation layer, a gate metal layer, a source drain metal layer, a flat layer, an interlayer insulation layer, a common electrode layer, a passivation layer and a pixel electrode layer on the substrate; and

forming a common signal adjustment structure at the common electrode layer, and the common signal adjustment structure and the common electrode layer are together employed to be a common electrode for transmitting a common signal to reduce a resistance in a common signal transmission process.

The common signal adjustment structure is a metal layer formed between the flat layer and the common electrode layer, and the metal layer is formed by other material with a better electrical conductivity, and a resistance thereof is smaller than common electrode layer.

The common signal adjustment structure is a first through hole formed at the common electrode layer, and the first through hole penetrates to the gate metal layer to connect the common electrode layer and the gate metal layer.

The common signal adjustment structure is a second through hole formed at the common electrode layer, and the second through hole penetrates to the source drain metal layer to connect the common electrode layer and the source drain metal layer.

Compared with prior art, the array substrate and the manufacture method thereof, the display device according to the present invention transmit the common signal with the common signal adjustment structure and the present common electrode layer together to effectively reduce the resistance of the common signal in the common signal transmission process, and to make the common signal distribution even.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a sectional structure diagram of an array substrate according to the first embodiment of the present invention.

FIG. 2 is a diagram of a pattern of a metal layer of the array substrate in the first embodiment of the present invention.

FIG. 3 is a sectional structure diagram of an array substrate according to the second embodiment of the present invention.

FIG. 4 is a sectional structure diagram of an array substrate according to the third embodiment of the present invention.

FIG. 5 is a flowchart of the manufacture method of the array substrate in the preferred embodiment of the present invention.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

Besides, the following descriptions for the respective embodiments are specific embodiments capable of being implemented for illustrations of the present invention with referring to appended figures. For example, the terms of up, down, front, rear, left, right, interior, exterior, side, etcetera are merely directions of referring to appended figures. Therefore, the wordings of directions are employed for explaining and understanding the present invention but not limitations thereto.

In the description of the invention, which needs explanation is that the term “installation”, “connected”, “connection” should be broadly understood unless those are clearly defined and limited, otherwise. For example, those can be a fixed connection, a detachable connection, or an integral connection; those can be a mechanical connection, or an electrical connection; those can be a direct connection, or an indirect connection with an intermediary, which may be an internal connection of two elements. To those of ordinary skill in the art, the specific meaning of the above terminology in the present invention can be understood in the specific circumstances.

Besides, in the description of the present invention, unless with being indicated otherwise, “plurality” means two or more. In the present specification, the term “process” encompasses an independent process, as well as a process that cannot be clearly distinguished from another process but yet achieves the expected effect of the process of interest. Moreover, in the present specification, any numerical range expressed herein using “to” refers to a range including the numerical values before and after “to” as the minimum and maximum values, respectively. In figures, the same reference numbers will be used to refer to the same or like parts.

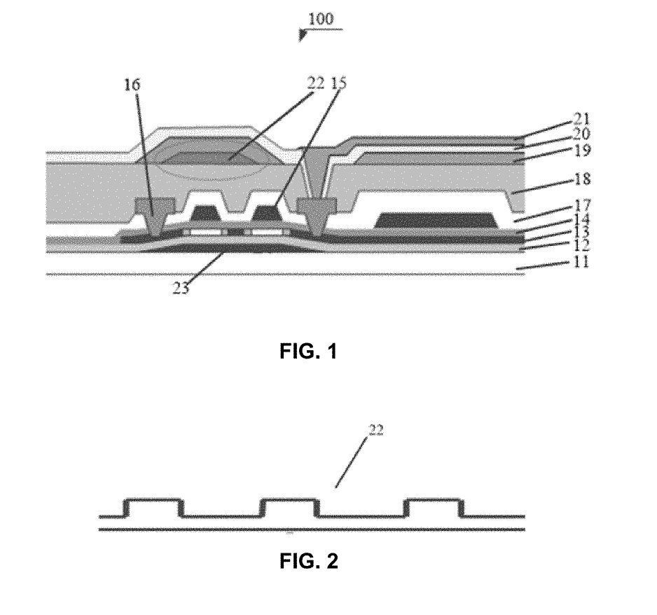

Please refer to FIG. 1. FIG. 1 is a sectional structure diagram of an array substrate 100 according to the first embodiment of the present invention. The array substrate 100 can be applied in a display device. The array substrate 100 comprises a substrate 11, a buffer layer 12, a semiconductor layer 13, a gate isolation layer 14, a gate metal layer 15, a source drain metal layer 16, a flat layer 17, an interlayer insulation layer 18, a common electrode layer 19, a passivation layer 20 and a pixel electrode layer 21, which are sequentially formed on the substrate.

The array substrate 10 further comprises a common signal adjustment structure formed at the common electrode layer 19, and the common signal adjustment structure and the common electrode layer 19 are together employed to be a common electrode for transmitting a common signal to reduce a resistance in a common signal transmission process.

In the preferred embodiments, the common signal adjustment structure is the metal layer 22 formed between the flat layer 17 and the common electrode layer 19, and the metal layer 22 is formed by other material with a better electrical conductivity, and a resistance thereof is smaller than common electrode layer 19. Preferably, the metal layer 22 is formed by molybdenum or alloy of aluminum, niobium, molybdenum. The pattern of the metal layer 22 can be referred to what is shown in FIG. 2. The metal layer 22 and the common electrode layer 19 are integrated into on to form a common electrode. After the common signal is transmitted through the common electrode formed with the metal layer 22 and the common electrode layer, the resistance in the transmission process is reduced, and the delay of the common signal is also reduced. Besides, the formed pattern and position of the metal layer 22 has smaller influence to the other structures, such the hole diameter, the parasitic capacitance of the array substrate 10. Meanwhile, the light from the external environment can be shielded by the metal layer 22 from the lighting channel (not shown) of the display device. Therefore, the display device can obtain better performance.

It is understandable that a light shielding layer 23 can be further provided between the substrate 11 and the buffer layer 12 to make the display device have better display result.

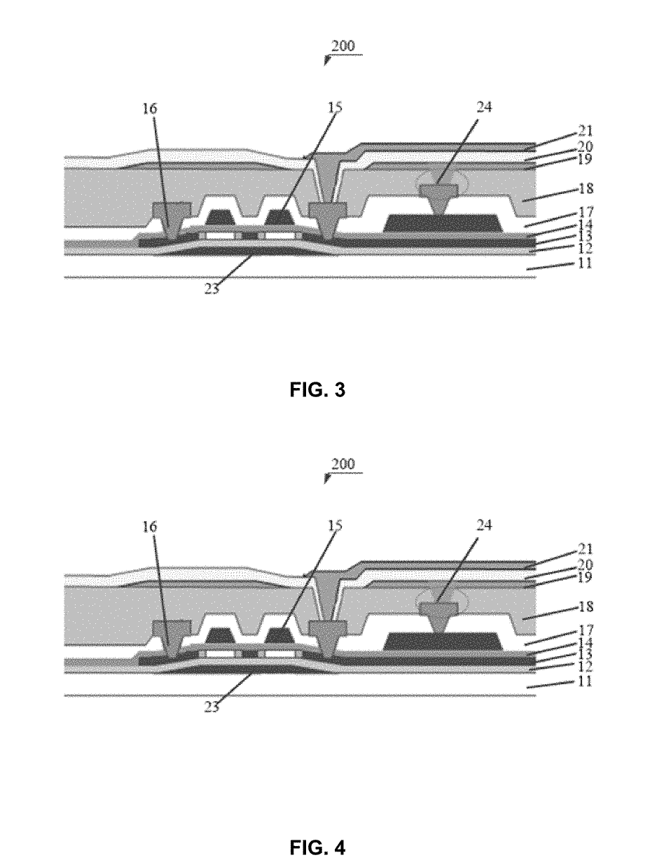

Please refer to FIG. 3. FIG. 3 is a sectional structure diagram of an array substrate 200 according to the second embodiment of the present invention. The structure of the array substrate 200 is almost the same with the array substrate 100 in the first embodiment. The difference merely is that the common signal adjustment structure of the array substrate 200 is a first through hole 24 formed at the common electrode layer 19. The first through hole 24 penetrates to the gate metal layer 15 to connect the common electrode layer 19 and the gate metal layer 15 to be unified as one. After the common signal can be transmitted through the gate metal layer 15 and the common electrode layer 19, the resistance in the transmission process is reduced, and the delay of the common signal is also reduced.

Please refer to FIG. 4. FIG. 4 is a sectional structure diagram of an array substrate 300 according to the second embodiment of the present invention. The structure of the array substrate 300 is almost the same with the array substrate 100 in the first embodiment. The difference merely is that the common signal adjustment structure of the array substrate 300 is a second through hole 25 formed at the common electrode layer 19. The second through hole 25 penetrates to the source drain metal layer 16 to connect the common electrode layer 19 and the source drain metal layer 16 to be unified as one. After the common signal can be transmitted through the source drain metal layer 16 and the common electrode layer 19, the resistance in the transmission process is reduced, and the delay of the common signal is also reduced.

The present invention further provides a display device, comprising the array substrate in the aforesaid embodiments, a color film substrate and a liquid crystal layer sandwiched between the array substrate and the color film substrate. The specific structure of the array substrate is described in the aforesaid embodiments. No detailed description is repeated here.

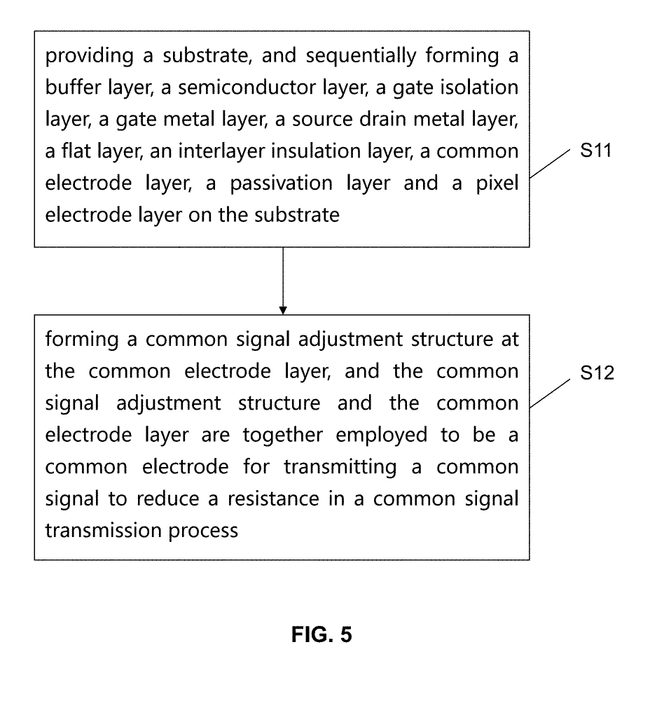

As shown in FIG. 5, the present invention further provides a manufacture method of an array substrate, and the method comprises steps of:

step S11, providing a substrate 11, and sequentially forming a buffer layer 12, a semiconductor layer, a gate isolation layer, a gate metal layer, a source drain metal layer, a flat layer, an interlayer insulation layer, a common electrode layer, a passivation layer and a pixel electrode layer on the substrate 11.

step S12, forming a common signal adjustment structure at the common electrode layer, and the common signal adjustment structure and the common electrode layer are together employed to be a common electrode for transmitting a common signal to reduce a resistance in a common signal transmission process.

In the first embodiment of the present invention, the common signal adjustment structure is the metal layer 22 formed between the flat layer 17 and the common electrode layer 19, and the metal layer 22 is formed by other material with a better electrical conductivity, and a resistance thereof is smaller than common electrode layer 19. Preferably, the metal layer 22 is formed by molybdenum or alloy of aluminum, niobium, molybdenum. The pattern of the metal layer 22 can be referred to what is shown in FIG. 2. The metal layer 22 and the common electrode layer 19 are integrated into on to form a common electrode. After the common signal is transmitted through the common electrode formed with the metal layer 22 and the common electrode layer, the resistance in the transmission process is reduced, and the delay of the common signal is also reduced. Besides, the formed pattern and position of the metal layer 22 has smaller influence to the other structures, such the hole diameter, the parasitic capacitance of the array substrate 10. Meanwhile, the light from the external environment can be shielded by the metal layer 22 from the lighting channel (not shown) of the display device. Therefore, the display device can obtain better performance.

In the second embodiment of the present invention, the common signal adjustment structure is a first through hole 24 formed at the common electrode layer 19. The first through hole 24 penetrates to the gate metal layer 15 to connect the common electrode layer 19 and the gate metal layer 15 to be unified as one. After the common signal can be transmitted through the gate metal layer 15 and the common electrode layer 19, the resistance in the transmission process is reduced, and the delay of the common signal is also reduced.

In the third embodiment of the present invention, the common signal adjustment structure is a second through hole 25 formed at the common electrode layer 19. The second through hole 25 penetrates to the source drain metal layer 16 to connect the common electrode layer 19 and the source drain metal layer 16 to be unified as one. After the common signal can be transmitted through the source drain metal layer 16 and the common electrode layer 19, the resistance in the transmission process is reduced, and the delay of the common signal is also reduced.

In conclusion, the array substrates 100, 200, 300 and the manufacture method thereof, the display device described in the embodiments of the present invention transmit the common signal with the common signal adjustment structure and the present common electrode layer together to effectively reduce the resistance of the common signal in the common signal transmission process, and to make the common signal distribution even.

In the description of the present specification, the reference terms, “one embodiment”, “some embodiments”, “an illustrative embodiment”, “an example”, “a specific example”, or “some examples” mean that such description combined with the specific features of the described embodiments or examples, structure, material, or characteristic is included in the utility model of at least one embodiment or example. In the present specification, the terms of the above schematic representation do not certainly refer to the same embodiment or example. Meanwhile, the particular features, structures, materials, or characteristics which are described may be combined in a suitable manner in any one or more embodiments or examples.

Above are embodiments of the present invention, which does not limit the scope of the present invention. Any modifications, equivalent replacements or improvements within the spirit and principles of the embodiment described above should be covered by the protected scope of the invention.

What is claimed is:

1. An array substrate, and the array substrate comprises a substrate, a buffer layer, a semiconductor layer, a gate isolation layer, a gate metal layer, a source drain metal layer, a flat layer, an interlayer insulation layer, a common electrode layer, a passivation layer and a pixel electrode layer, which are sequentially formed on the substrate, wherein the array substrate further comprises a common signal adjustment structure formed at the common electrode layer, and the common signal adjustment structure and the common electrode layer are together employed to be a common electrode for transmitting a common signal to reduce a resistance in a common signal transmission process.

2. The array substrate according to claim 1, wherein the common signal adjustment structure comprises a metal layer between the flat layer and the common electrode layer, and the metal layer is formed by other material with a better electrical conductivity, and a resistance thereof is smaller than common electrode layer.

3. The array substrate according to claim 2, wherein the metal layer is formed by molybdenum or alloy of aluminum, niobium, molybdenum.

4. The array substrate according to claim 1, wherein the common signal adjustment structure comprises a first through hole formed at the common electrode layer, which penetrates to the gate metal layer to connect the common electrode layer and the gate metal layer.

5. The array substrate according to claim 1, wherein the common signal adjustment structure comprises a second through hole formed at the common electrode layer, which penetrates to the source drain metal layer to connect the common electrode layer and the source drain metal layer.

6. A display device, wherein the display device comprises an array substrate, a color film substrate and a liquid crystal layer sandwiched between the array substrate and the color film substrate, and the array substrate comprises a substrate, a buffer layer, a semiconductor layer, a gate isolation layer, a gate metal layer, a source drain metal layer, a flat layer, an interlayer insulation layer, a common electrode layer, a passivation layer and a pixel electrode layer, which are sequentially formed on the substrate, wherein the array substrate further comprises a common signal adjustment structure formed at the common electrode layer, and the common signal adjustment structure and the common electrode layer are together employed to be a common electrode for transmitting a common signal to reduce a resistance in a common signal transmission process.

7. The display device according to claim 6, wherein the common signal adjustment structure comprises a metal layer between the flat layer and the common electrode layer, and the metal layer is formed by other material with a better electrical conductivity, and a resistance thereof is smaller than common electrode layer.

8. The display device according to claim 7, wherein the metal layer is formed by molybdenum or alloy of aluminum, niobium, molybdenum.

9. The display device according to claim 6, wherein the common signal adjustment structure comprises a first through hole formed at the common electrode layer, which penetrates to the gate metal layer to connect the common electrode layer and the gate metal layer.

10. The display device according to claim 6, wherein the common signal adjustment structure comprises a second through hole formed at the common electrode layer, which penetrates to the source drain metal layer to connect the common electrode layer and the source drain metal layer.

11. A manufacture method of an array substrate, wherein the method comprises:
providing a substrate, and sequentially forming a buffer layer, a semiconductor layer, a gate isolation layer, a gate metal layer, a source drain metal layer, a flat layer, an interlayer insulation layer, a common electrode layer, a passivation layer and a pixel electrode layer on the substrate; and
forming a common signal adjustment structure at the common electrode layer, and the common signal adjustment structure and the common electrode layer are together employed to be a common electrode for transmitting a common signal to reduce a resistance in a common signal transmission process.

12. The manufacture method of the array substrate according to claim 11, wherein the common signal adjustment structure is a metal layer formed between the flat layer and the common electrode layer, and the metal layer is formed by other material with a better electrical conductivity, and a resistance thereof is smaller than common electrode layer.

13. The manufacture method of the array substrate according to claim 11, wherein the common signal adjustment structure is a first through hole formed at the common electrode layer, and the first through hole penetrates to the gate metal layer to connect the common electrode layer and the gate metal layer.

14. The manufacture method of the array substrate according to claim 11, wherein the common signal adjustment structure is a second through hole formed at the common electrode layer, and the second through hole penetrates to the source drain metal layer to connect the common electrode layer and the source drain metal layer.
